(19) United States
(12) Patent Application Publication
(10) Pub. No.: US 2026/0322057 A1
(43) Pub. Date: Oct. 15, 2026

(54) ELECTRO-OPTICAL SYSTEM HAVING MECHANICALLY DECOUPLING EMC SEAL, AND LASER SYSTEM HAVING SAME

(71) Applicant: TRUMPF Lasersystems for Semiconductor Manufacturing SE, Ditzingen (DE)

(72) Inventors: Tom Schilling, Stuttgart (DE); Timo Nonnenmacher, Tamm (DE); Michael Ruge, Stuttgart (DE); Sascha Fröhlich, Tamm (DE)

(21) Appl. No.: 19/696,341

(22) Filed: Jun. 3, 2026

Related U.S. Application Data
(63) Continuation of application No. PCT/EP2024/082737, filed on Nov. 18, 2024.

(30) Foreign Application Priority Data
Dec. 7, 2023 (DE) 10 2023 134 302.5

(51) Int. Cl. H01S 3/00; H01S 3/03; H01S 3/097; H01S 3/0975

(52) U.S. Cl. CPC H01S 3/0071; H01S 3/03; H01S 3/09702; H01S 3/0975

(57) ABSTRACT

An electro-optical system includes an electrical system part for generating and/or guiding non-optical electromagnetic fields, and an optical system part for generating and/or guiding light. The electrical system part and the optical system part are arranged relative to one another in such a way that the light is allowed to pass from the electrical system part into the optical system part. The electro-optical system further includes a shielding element surrounding a coupling region to electromagnetically shield the coupling region. The shielding element forms an electrically conductive connection between the electrical system part and the optical system part. The shielding element is flexibly deformable to mechanically decouple the electrical system part from the optical system part.

### CROSS REFERENCE TO RELATED APPLICATIONS

This application is a continuation of International Application No. PCT/EP2024/082737 (WO 2025/119639A1 ), filed on Nov. 18, 2024, and claims benefit to German Patent Application No. DE 10 2023 134 302.5, filed on Dec. 7, 2023. The aforementioned applications are hereby incorporated by reference herein.

### FIELD

Embodiments of the present invention relate to an electrical and optical system having an electromagnetic compatibility (EMC) seal, and to a laser system equipped with such an electronic and optical system.

### BACKGROUND

Nowadays electrical systems or installations are used in a wide variety of forms and applications and can have a considerable degree of complexity in the process. At the same time, requirements must be met with regard to electromagnetic compatibility (EMC). Therefore, special measures are often necessary to avoid the unintentional escape of electromagnetic radiation, especially in systems or installations which cannot be feasibly accommodated in a single housing. However, such measures can in turn cause other problems, for example in the form of transmission paths for disturbances or mechanical forces or vibrations.

As one solution approach, U.S. Pat. No. 10,561,046 B2 describes a seal for a connection between two housing components of an electrical or electronic device in accordance with an IP rating and sealed with regard to EMC. The seal has a sealing body and a metallic carrier connected thereto, having a multiplicity of contact segments for electrically contacting boundary surfaces of the two housing components. The seal is pressed in between said boundary surfaces. Although an EMC seal can be achieved in this way, mechanical forces may be able to be transmitted between the housing components via the seal, which can lead to an undesired disturbing or interfering effect.

### SUMMARY

Embodiments of the present invention provide an electro-optical system. The electro-optical system includes an electrical system part for generating and/or guiding non-optical electromagnetic fields, and an optical system part for generating and/or guiding light. The electrical system part and the optical system part are arranged relative to one another in such a way that the light is allowed to pass from the electrical system part into the optical system part. The electro-optical system further includes a shielding element surrounding a coupling region to electromagnetically shield the coupling region. The shielding element forms an electrically conductive connection between the electrical system part and the optical system part. The shielding element is flexibly deformable to mechanically decouple the electrical system part from the optical system part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a detail of an electro-optical system with connected but mechanically decoupled system parts;

FIG. 2 shows a schematic illustration of a detail of an electromagnetic sealing region between the system parts;

FIG. 3 shows a schematic exploded view of a detail of components from the sealing region; and

FIG. 4 shows a schematic sectional illustration of a detail of the components from the sealing region.

### DETAILED DESCRIPTION

Embodiments of the present invention can enable safe, robust and precise operation of a multi-part electrical and optical system.

The electro-optical system according to the embodiments of the invention comprises an electrical system part for generating and/or guiding non-optical electromagnetic radiation or fields and an optical system part for generating and/or guiding light. Light is to be understood here in the broader sense to mean in particular the visible spectral range or also the adjacent infrared and/or UV spectral ranges. In the present sense, non-optical radiation or fields accordingly lie in spectral ranges outside these, that is to say for example in the high frequency or a radio frequency range (HF, RF). The fact that the system according to embodiments of the invention is referred to here as an electro-optical system means that it has primarily electrical or electrically operating functions and primarily optical or optically operating functions and parts or components. The system does therefore not necessarily have to utilize an electro-optical effect in the actual sense.

In the system according to embodiments of the invention, the electrical system part and the optical system part are arranged relative to one another in such a way that the light can pass through a connecting or coupling region from the electrical system part into the optical system part or vice versa from the optical system part into the electrical system part. The system according to embodiments of the invention further comprises at least one shielding element, that is to say an EMC sealing element, which surrounds the coupling region for electromagnetically shielding or sealing it. For example, the shielding element can thus extend in the circumferential direction about a propagation or beam direction of the light, which extends through the coupling region between the two system parts, and in doing so extend from the electrical system part in or along the propagation or beam direction as far as the optical system part. In this case, the shielding element is thus arranged in such a way that it forms or produces an electrically conductive connection between the electrical system part and the optical system part in the coupling region. For this purpose, the shielding element can be fastened in an electrically conductive manner, for example, on one side to the electrical system part, that is to say, for instance, a housing of the electrical system part, and on its other side to the optical system part or a housing of the optical system part.

For example, the two system parts can each have a dedicated electromagnetically shielding housing. However, these can each have apertures or recesses on at least one side, in particular on mutually facing sides, in order to allow the light to pass through there. However, the escape of electromagnetic radiation or fields into the environment should be prevented there, in particular on the electrical system part. In the present case, this is achieved by the shielding element. In a laser system, the electrical system part can comprise, for example, components for electrical or electromagnetic pumping, that is to say for amplifying the laser light, while the optical system part can comprise, for example, optical components, such as mirrors and/or lenses, for deflecting and/or shaping the laser light or laser beam.

According to embodiments of the invention, the shielding element for mechanically decoupling the electrical system part from the optical system part is designed to be repeatedly and reversibly flexibly deformable, in particular inelastically or non-elastically, without damage occurring. In other words, the shielding element can thus be arranged and designed here for minimizing the transmission of mechanical forces and vibrations from the one system part to the other system part, while simultaneously maintaining the electromagnetic shielding or sealing effect. By means of an at least substantially non-elastic deformability of the shielding element at least in regions, it is possible to avoid or minimize restoring forces that otherwise occur in the event of a deformation of the shielding element or a mechanical influencing of one or both system parts resulting therefrom. In particular, for this purpose, the shielding element can neither be clamped or braced between the two system parts nor pressed in between or by the latter. For example, the shielding element can be flexibly deformable in a central region between the two system parts and at least substantially free of mechanical stresses or forces. In its end regions, in which the shielding element is in mechanical contact with the system parts, that is to say is fastened or bears against said system parts, mechanical forces or stresses can potentially act when one of the two parts of the system is deformed relative to the other in order to ensure, and for example also maintain, the mechanical and electromagnetically tight or sealing contact between the shielding element and the system parts.

In the intended installation position, the shielding element thus allows a damage-free relative movement between the two system parts while maintaining the EMC shielding effect. The mechanical decoupling is thus achieved on account of the flexibility, that is to say the pliability or compliance or the lowest possible stiffness of the shielding element. In previous approaches to solutions, there is often the problem that, in particular, electrical system parts, for example for RF generation, can be prone to mechanical vibrations or oscillations or can possibly be exposed to mechanical forces on their part, which can be transmitted to an optical system part in the case of a rigid or mechanical force-transmitting coupling to said optical system part. However, optical system parts can be highly sensitive or susceptible to mechanical forces, vibrations, shocks, or the like. Thus, in the case of optically sensitive components, for example components of a laser system, even relatively low forces of less than 10 Newton can have a significant influence on optical alignment and thus ultimately on optical performance, efficiency or effectiveness. The term optical alignment refers to the setting or alignment of optical component axes or of the beam path or a beam axis of the light guided in the electro-optical system, such as a laser beam. This problem can be addressed by embodiments of the present invention. This is also supported by the fact that, with the arrangement of the shielding element between the two system parts, that is to say between corresponding housings for example, the shielding element is automatically arranged or can be arranged at a certain distance from mechanically sensitive or vibration-sensitive optical components of the optical system part. This can make it easier to avoid a direct coupling or effective path for mechanical forces between the shielding element and the corresponding optical components whilst still producing or ensuring the electromagnetic shielding or sealing of the entire electro-optical system overall. This can be seen, for example, in comparison with arranging a corresponding sealing point for the electromagnetic seal or shielding directly on correspondingly sensitive optical components, since it can then be at least much more difficult to arrange such a seal or shielding in an at least substantially force-free manner with respect to the optical components, that is to say implemented in a mechanically decoupled manner.

Here, the shielding element can be so flexible or deformable in itself that, in the event of movements, thermal expansions or contractions, vibrations and the like, force transmissions from one system part to the other system part via the shielding element, which are strong enough to cause errors in the optical alignment, no longer occur. Thus, a stable optical alignment can be achieved at all operating points of the electro-optical system or of an overall installation comprising such a system. If, for example, a steel bellows were used instead for electromagnetic shielding, excessive mechanical forces could be transmitted from one system part to the other due to the rigidity, even if the steel bellows were mounted on the system parts under only low mechanical stress or prestress.

According to some embodiments, the electrical system part is or comprises at least part of an RF generator and/or an amplifier. In particular, the RF generator can be designed as an RF generator for a laser system or for use in a laser system. Generators of this type can generate mechanical vibrations during operation, and so mechanical decoupling by means of the shielding element can be particularly useful here. In particular, the amplifier can be configured or designed to amplify laser light. In this case, the electrical system part can thus comprise, for example, terminals and/or electrodes, in particular at least one pair of RF electrodes or pump electrodes and/or coils and/or the like. By means of such devices, mechanical vibrations of the most varied frequencies can also be generated during operation and, for example, thermal expansion effects can be brought about. In particular in the application of a laser system, the optical system part can additionally be particularly susceptible to such vibrations and/or—for example thermally induced—relative movements or changes in position. At the same time, however, the use of HF energy, that is to say a correspondingly purely electrical or electromagnetic coupling-in of pump energy for example, can be realized particularly easily and controlled particularly accurately.

According to some embodiments, the optical system part is or comprises a beam source or a beam generator and/or an optical unit for laser light. There, mechanical forces and vibrations can be particularly critical, for example with regard to optical alignment, efficiency and reliable functioning. Accordingly, the mechanically decoupling effect of the shielding element can be particularly useful here. The optical unit can have one or more optical components or parts, for example for light or beam guidance and/or shaping. For example, the optical unit can comprise at least one mirror and/or a lens and/or a beam splitter and/or a phase element for impressing or displacing a phase and/or the like.

According to some embodiments, the shielding element is flexibly, in particular non-elastically, deformable in all three spatial directions, at least in regions, without damage occurring. Thus, a particularly complete and effective mechanical decoupling between the electrical system part and the optical system part can be realized. Depending on the configuration or function of the system parts, particularly robust, reliable and/or precise operation can thus be made possible. In order to enable the flexibility or deformability of the shielding element provided here, it can be correspondingly over-dimensioned, for example, in a central region, i.e., between its ends or fastening points, that is to say have additional material as the minimum required for connecting the two system parts, and/or be free of continuous stiff or rigid elements or structures which are in particular connected to one another and extend longitudinally in different directions.

According to some embodiments, the shielding element is designed in such a way that, while maintaining the electrically conductive connection between the two system parts, its extent and/or position in all spatial directions in which it is flexibly deformable can be changed, at least in regions, in each case by at least 5 mm from a neutral or central position without damage occurring. The neutral or central position can be that position or arrangement of the shielding element and of the two system parts where or in which an equal change of the shielding element in each dimension or a relative movement of the two system parts in both directions is possible without destroying the shielding element or causing it to detach from one of the system parts. From there, for example, the shielding element can thus be changeable by at least 5 mm and can be shortened by at least 5 mm in the connecting direction between the two system parts, and enable a transverse movement of the one system part relative to the other system part by at least 5 mm in each case in transverse directions perpendicular thereto in both directions, that is to say in the positive and negative vertical directions and in the positive and negative lateral directions. Such a design of the shielding element can typically be realized relatively simply and with little outlay, and without requiring excessive installation space and without excessive additional weight, whilst offering many practical applications sufficient scope for reliably and robustly mechanically decoupling the two system parts.

According to some embodiments, the shielding element is designed in such a way that it allows the two system parts to rotate relative to one another by several degrees about all three spatial axes without damage occurring. In other words, for example, one of the two system parts can then be rotated about one or more arbitrary spatial axes relative to the other system part, for example by at least or up to 5° or by at least or up to 10°, without damaging the shielding element and without interrupting the electromagnetic shielding effect. This can allow a particularly effective mechanical decoupling of the two system parts and thus ultimately likewise benefit particularly robust, reliable and precise operation of the corresponding system.

According to some embodiments, the shielding element is formed at least partially, in particular only partially, from a metallic material. This can enable particularly effective electromagnetic shielding with particularly low material costs. In order to achieve the flexibility or deformability of the shielding element, the metallic material can be configured, for example, as a film or as a coating of a flexible or deformable carrier material or embedded in a flexible or deformable matrix of a carrier material.

According to some embodiments, the shielding element is designed at least or only partially or at least or only in regions as a textile and/or as a mat and/or as a net or net structure. As a result, the flexibility and deformability described elsewhere can be realized whilst offering particularly effective mechanical decoupling at the same time. The textile used here can be, for example, a so-called EMC textile, which can contain, for example, metallic threads or wires woven into it. A mat can, for example, be formed at least partially from an electrically conductive elastomer or an elastomer or rubber material with an electrically conductive, in particular metallic, material embedded therein or applied thereto as a coating. A net-like design can be realized, for example, in the form of a net or grid structure or a mesh of electrically conductive wires, such as a copper net or copper wire mesh. In this case, correspondingly thin wires, for example scrape-pull wires or fine-pull wires, can be used in order to achieve the described flexible deformability. In the configuration proposed here, the shielding element can be or can be designed to be particularly simple and effective whilst also electromagnetically shielding and pliable or compliant, that is to say does not hold its shape independently without support and is thus correspondingly flexibly, in particular non-elastically, deformable.

According to some embodiments, a fixed hollow structure is situated or extends in the coupling region between the electrical system part and the optical system part. The shielding element is then placed on the outside of this fixed hollow structure at least in regions. By way of example, the shielding element can be pulled onto the hollow structure from one side in the direction of, or parallel to, the central axis of the hollow structure before the installation of the hollow structure. The fixed hollow structure can in particular be a hollow cylinder or a ring. Despite the flexibility and deformability of the shielding element, a reliable ability to transmit light through the coupling region can always be ensured by this fixed hollow structure. In order to avoid transmitting mechanical forces or vibrations between the system parts via the fixed hollow structure, it can be guided, for example, through respective openings in the system parts or their housings and can be movably mounted therein in each case. Likewise, the fixed hollow structure, for example, cannot extend at each of its ends completely as far as the optical system part or the housing thereof, such that a gap or spacing can be provided there. The fixed hollow structure can then be supported or held, for example, by the shielding element and/or in turn support the shielding element, i.e., can be used to a certain extent for shaping. The shielding element can in turn be fastened to or in one or both of the system parts or their housings. In this case, the shielding element can thus possibly surround or bridge the gaps or distances between the hollow structure and the system parts or housings and electromagnetically shield or seal them. For example, in a laser system, the hollow structure can be a closed hollow cylinder, for instance made of quartz glass or the like. It can contain a laser medium or laser amplifying medium, in particular a gaseous laser medium. Energy can be coupled into the electrical system part, for example, by means of electrodes arranged next to it, which energy can then be transmitted to laser light passing through. Such a hollow structure can extend, for example, from the electrical system part into the coupling region or into the adjoining optical system part. Likewise, such a hollow structure can extend, for example, through the electrical system part and project from said electrical system part or its housing on mutually opposite sides, for instance into a coupling region or optical system part arranged there in each case.

According to some embodiments, it is provided that the shielding element is frictionally fastened to or bears frictionally against the electrical system part and/or the optical system part at least in regions. For example, the shielding element can be fastened to the system parts by means of a respective clamping or by means of a respective clamping ring. If the shielding element is fastened, for example, to a respective housing of the system parts, these housings can have an opening or recess through which light can pass or be transmitted. The shielding element can then be fastened around this opening or recess. A frictional fastening or connection can in this case allow particularly good or tight contact between the shielding element and the respective system part or housing and thus a particularly good electromagnetic shielding or sealing effect. Moreover, a frictional connection can prevent damage to the shielding element and thus enable a particularly flexible and maintenance-friendly construction of the electro-optical system. By means of the frictional connection or coupling, a relative movement between the shielding element and the respective system part can be made possible without loss of the electromagnetic sealing effect, for example in the radial direction, that is to say perpendicular to the light or beam propagation direction in the coupling region. For this purpose, the shielding element can have, for example, a perforated disc, the internal diameter of which is large enough to enable a relative movement in the radial direction, for example relative to the hollow structure mentioned elsewhere, which can be passed through the perforated disc here. With their side facing the respective system part, the perforated discs can bear frictionally against the system part or a corresponding counterpart which, in particular, can be fastened to the respective system part in a positionally fixed manner relative to the system part or can be part of the respective system part or its housing.

According to some embodiments, the shielding element has at least one fold and/or corrugation, that is to say one or more creases or undulating distortions or bulges, at least in the intended installation position or during or immediately after initial installation of the system. In this case, the at least one fold and/or corrugation runs transversely to a connecting direction or connecting line running in the coupling region from the electrical system part to the optical system part. The shielding element can thus be shaped, for example, like a bellows or—for example in the case of the configuration described elsewhere as a textile or mat or net—be compressed in the connecting direction in order to bring about or produce a folding effect. The at least one fold or corrugation can be at least partially pulled flat when the two system parts move away from one another in or along the connecting direction. In this case, the length of the shielding element can thus increase in or along the connecting direction, substantially without transmitting corresponding tensile forces from the one system part to the other. Likewise, in the case of a shortening or compression of the shielding element in or along the connecting direction, one or more folds or corrugations can arise and/or one or more predefined folds or creases or fold or crease lines can function as predefined points or projections for warping or raising or bulging of the shielding element. In this way, the transmission of corresponding pressure forces between the system parts can be avoided or at least reduced or kept particularly low. The configuration of the shielding element proposed here can thus enable a particularly low-resistance shortening or compression and lengthening or stretching of the shielding element and thus a particularly effective mechanical decoupling of the two system parts from one another.

According to some embodiments, the electro-optical system also has at least one second optical system part. Accordingly, the optical system part mentioned elsewhere can also be referred to as the first optical system part. The second optical system part is connected to the electrical system part via a corresponding second coupling region, wherein this second coupling region is electromagnetically shielded by means of a dedicated or second shielding element. The two optical system parts can be arranged on different, in particular mutually opposite, sides of the electrical system part, for example, or can be coupled or connected thereto. The second shielding element can be constructed or designed similar to the shielding element mentioned elsewhere, wherein the latter can also be referred to as the first shielding element. In the embodiment proposed here, the system according to embodiments of the invention has more than two system parts, which can make a respective mechanical decoupling of the system parts from one another even more significant and useful.

Embodiments of the present invention also relate to a laser system comprising the electro-optical system according to embodiments of the invention. In this case, this electro-optical system—and thus also the laser system according to embodiments of the invention—is configured for generating and/or amplifying laser light or laser radiation. In this case, the electrical system part can be configured in particular for providing electrical or electromagnetic energy. In particular, the laser system according to embodiments of the invention can be, or correspond to, the laser system mentioned in connection with the electro-optical system according to embodiments of the invention.

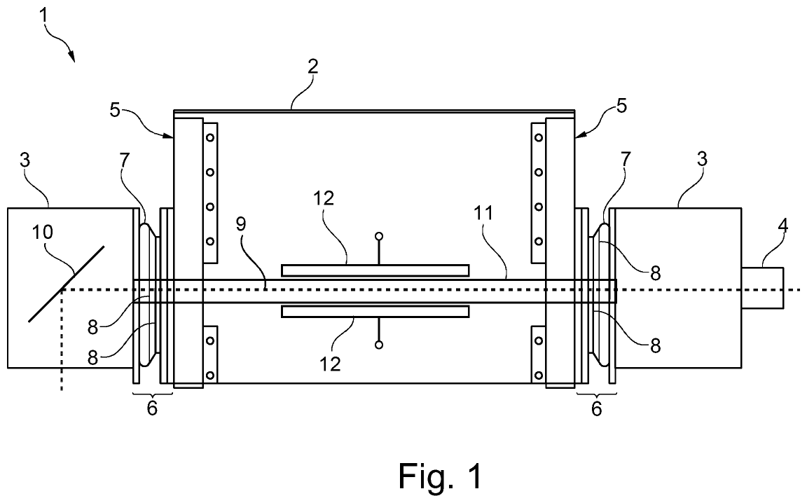

FIG. 1 shows a schematic illustration of a section of a system 1. Here, the system 1 comprises an electrical system part 2 and an optical system part 3, and so it can also be referred to as an electro-optical system 1. The electrical system part 2 is used for generating or providing electromagnetic high-frequency or radio-frequency fields, for example for amplifying laser light. The optical system part 3 is used for generating and/or guiding laser light. Corresponding laser light can then be output, for example, via an output 4 indicated schematically here.

By way of example, the system 1 can have a plurality of such optical system parts 3, for instance on both sides of the electrical system part 2, or the optical system part 3 can have a multi-part design.

In order to allow the laser light to be passed through the system parts 2, 3, they are arranged relative to one another in a certain way. However, in order to prevent electromagnetic fields, that is to say for example the RF radiation, from escaping from the electrical system part 3, the two system parts 2, 3 are connected to one another. In particular, however, the electrical system part 2 is not always free of vibrations or, for example thermally induced, movements or changes in size. The transmission of such disturbances to the optical system part 3 or optically effective components possibly present therein could, like external forces, generally have a negative effect, for example, on beam guidance, beam quality and/or the like of the laser light, for example due to displacement and/or deformation of components of the optical system part 3. Therefore, a decoupling of the two system parts 2, 3 in terms of movement and/or force transmission would be desirable. At the same time, however, in the sense of electromagnetic compatibility, uncontrolled propagation of electromagnetic radiation from the electrical system part 2 or the system 1 as a whole into the environment should also be avoided.

For this purpose, in the present case, the optical system parts 3 are connected to side walls 5 of the electrical system part 2 in each case via an interposed coupling region 6. A respective shielding element 7 is situated in the coupling regions 6. The shielding elements 7 are used for electromagnetic shielding or sealing and are designed in this case for the greatest possible mechanical decoupling of the optical system parts 3 from the electrical system part 2. For this purpose, the shielding elements 7 are formed at least partially from an electrically conductive material, whereby an electrically conductive contact is produced between the respective optical system part 3 and the electrical system part 2. At the same time, the shielding elements 7 are flexible or flexibly deformable. For example, the shielding elements 7 can be formed from an electromagnetically shielding textile or a corresponding mat or mesh structure and have such a low stiffness that they can be moved in all six translational and rotational degrees of freedom without transmitting significant mechanical forces between the respective mutually coupled system parts 2, 3. As a result of this mechanically decoupling configuration or effect of the shielding elements 7, it is thus possible in particular to avoid or reduce external mechanical influences on the respective optical system part 3, such that a corresponding negative influence on, for example, the alignment of optical components of the respective optical system part 3 can be avoided.

In order to achieve the corresponding flexibility or deformability of the shielding elements 7, these can be formed not only from a correspondingly flexible material, but also each having one or more folds 8. By way of example, the housings of the electrical system part 2 and of the optical system part 3 can have, in particular round, openings or passages or apertures on their mutually facing sides, wherein in each case one end of the respective shielding element 7 is fastened therearound. In this case, the shielding elements 7 can be folded or corrugated and be mounted under at most a low degree of mechanical stress. When the system 1 is designed as intended, mechanical forces of at most 10 N or at most 5 N or at most 1 N can for example be applied to the fastening or contact points between the shielding elements 7 and the respective system part 2, 3. Consequently, the shielding elements 7 enable an at least virtually mechanically decoupled RF seal on optically sensitive components, that is to say in this case on the optical system parts 3, and an at least substantially force-free relative movement of the system parts 2, 3 with respect to one another without loss of the RF sealing, that is to say of the EMC shielding. This is the case since the folds 8 offer or can enable sufficient compensating movements or compensating changes in shape of the shielding elements 7, such that, for example, relative movements of the mutually coupled system parts 2, 3 of at least 5 mm can be possible in all three spatial directions and rotations of, for example, up to 10° or more can be possible about all three spatial axes relative to one another.

Here, the system 1 is designed for a laser installation or as part of a laser installation. For clarification, a laser beam 9 is indicated, which passes through the system 1. The laser beam 9 can be deflected in the one optical system part 3 at a mirror 10 arranged there in the direction of the electrical system part 3; this mirror 10 can thus be one of the aforementioned optical components or one of the aforementioned optically sensitive components. In this case, a gas tube 11, for example made of quartz glass or the like, is arranged in the electrical system part 2. For example, this gas tube 11 extends here from the one optical system part 3 through the electrical system part 2 to the other optical system part 3 and through the interposed coupling regions 6. The gas tube 11 is arranged such that the laser beam 9 can pass through the gas tube 11 in the axial direction. The gas tube 11 can contain a gas through which the laser beam 9 passing through can be amplified. For this purpose, the electrical system part 2 also comprises electrodes 12 for generating the RF fields. These electrodes can thus be supplied with RF power and, due to their arrangement around the gas tube 11, can couple energy into the gas contained therein.

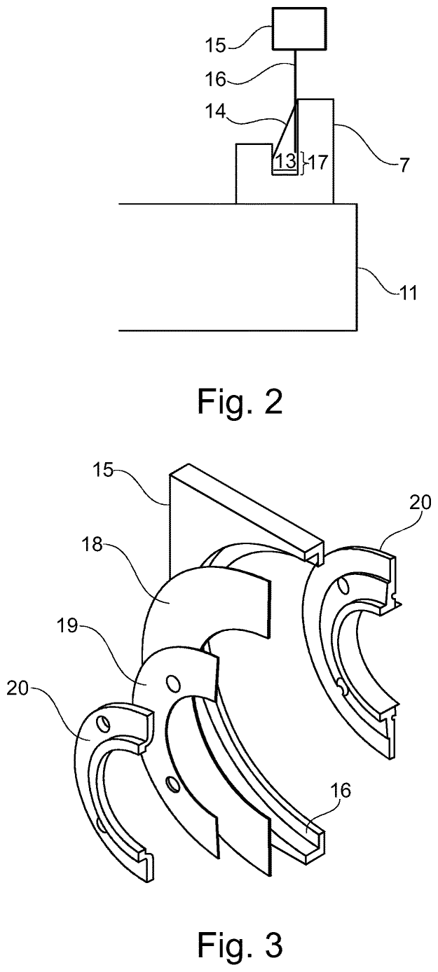

To illustrate the electromagnetically sealed connection of the shielding elements 7 to the system part 2, 3, FIG. 2 shows a schematic sectional illustration of a detail. Here, an end-side part of a shielding element 7 annularly surrounding the gas tube 11 is illustrated. This has a depression 13 or groove extending in the radial direction and a spring element 14 arranged therein or thereon. Here, the depression 13 is only shown purely schematically and, by way of example, with a rectangular shape and can likewise have, for example, a rounded base and/or oblique flanks or side walls. The spring element 14 can be fastened, for example, at its inner edge facing the gas tube 11, while its outer edge can be free or loose.

Also shown is a perforated disc 15 annularly surrounding the gas tube 11 and the shielding element 7, or its part shown here. This perforated disc 15 can be fixed, for example, to the respective system part 2, 3 or can be part of its housing. The perforated disc 15 has an annular region or collar projecting inward, that is to say in the direction of the gas tube 11, and which is referred to here as a spring contact element 16. Here, this protrudes partially into the depression 13. In particular, the spring contact element 16 does not reach the base of the depression 13. Thus, a compensation region 17 remains between the spring contact element 16 and the base of the depression 13, which compensation region enables a movement of the shielding element 7 relative to the perforated disc 15—and thus also relative to the respective system part 2, 3—in the radial direction.

The spring element 14 can be mechanically prestressed, such that its free end, that is to say its outer edge, applies a force in the direction of the opposite inner wall of the depression 13. For this purpose, the spring element 14 can be manufactured, for example, from spring steel. The spring element 14 thus presses against the spring contact element 16 and the latter presses against the opposite inner wall of the depression 13. Thus, an electromagnetically sealing frictional contact is produced there between the shielding element 7 and the respective system part 2, 3, which contact allows a relative movement and can thus dampen force transmission.

For further illustration, FIG. 3 shows an exploded view of a detail, of components such as can be used in the vicinity of one of the coupling regions 6 in order to realize the electromagnetically sealed connection of the shielding element 7 to the respective system part 2, 3 there. The perforated disc 15, which can be fixed to the respective system part 2, 3, is also illustrated here by way of example. In the variant shown here, an axial compression spring disc 18 and a radial decoupling spring disc 19 are illustrated, for example as parts of the shielding element 7. These can be manufactured, for example, from spring steel. The axial compression spring disc 18 can functionally correspond to the spring element 14 of FIG. 2, that is to say effect a pressing force in the axial direction, in order to ensure that the shielding element 7 bears against the perforated disc 15 and thus against the respective system part 2, 3. The radial decoupling spring disc 19 can bear against the axial compression spring disc 18, but have a smaller diameter than the latter, thus allowing for compensating movements of the shielding element 7 relative to the perforated disc 15 or the respective system part 2, 3 in the radial direction—that is to say perpendicular to the beam direction of the laser beam 9. In the axial direction, said components can be held together by clamping rings 20.

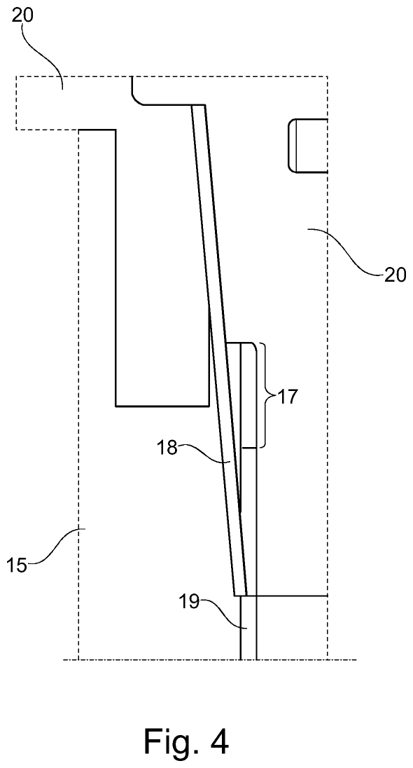

For further illustration, FIG. 4 shows a detailed schematic view of a detail of the components of FIG. 3 in the intended installation position. It can be seen here that the oblique or bent axial compression spring disc 18 can bear both against the radial decoupling spring disc 19 and against the perforated disc 15 and/or the clamping rings 20. The radial decoupling spring disc 19, which is smaller in diameter, can carry out or allow for compensating movements into the compensating region 17 in the radial direction while maintaining contact with the axial compression spring disc 18.

Overall, the described examples show the realization and use of a mechanically decoupled RF seal.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 System
2 Electrical system part
3 Optical system part
4 Output
5 Side wall
6 Coupling region
7 Shielding element
8 Fold
9 Laser beam
10 Mirror
11 Gas tube
12 Electrodes
13 Depression
14 Spring element
15 Perforated disc
16 Spring contact element
17 Compensation region
18 Axial compression spring washer
19 Radial decoupling spring disc
20 Clamping rings

1. An electro-optical system, comprising:
an electrical system part for generating and/or guiding non-optical electromagnetic fields, and
an optical system part for generating and/or guiding light, wherein the electrical system part and the optical system part are arranged relative to one another in such a way that the light is allowed to pass from the electrical system part into the optical system part, and
a shielding element surrounding a coupling region to electromagnetically shield the coupling region, wherein the shielding element forms an electrically conductive connection between the electrical system part and the optical system part, and the shielding element is flexibly deformable to mechanically decouple the electrical system part from the optical system part.

2. The electro-optical system as claimed in claim 1, wherein the electrical system part comprises at least a part of a high-frequency generator for a laser system, and/or an amplifier for amplifying laser light.

3. The electro-optical system as claimed in claim 1, wherein the optical system part comprises a beam generator and/or an optical unit for laser light.

4. The electro-optical system as claimed in claim 1, wherein the shielding element is flexibly deformable in three spatial directions.

5. The electro-optical system as claimed in claim 1, wherein the shielding element is configured in such a way that, while maintaining the electrically conductive connection between the electrical system part and the optical system part, an extent and/or a position of the shielding element in all spatial directions in which the shielding element is flexibly deformable is changeable by at least 5 mm from a central position.

6. The electro-optical system as claimed in claim 1, wherein the shielding element is configured so as to allow the electrical system part and the optical system part to rotate relative to one another by several degrees about three spatial axes without causing damage.

7. The electro-optical system as claimed in claim 1, wherein the shielding element is formed at least partially from a metallic material.

8. The electro-optical system as claimed in claim 1, wherein the shielding element is configured as a textile or a mat or a net.

9. The electro-optical system as claimed in claim 8, further comprising:
a fixed hollow structure extending in the coupling region between the electrical system part and the optical system part, wherein the shielding element is placed on an outer side of the fixed hollow structure.

10. The electro-optical system as claimed in claim 1, wherein the shielding element bears frictionally against the electrical system part and/or against the optical system part.

11. The electro-optical system as claimed in claim 1, wherein the shielding element has at least one fold and/or a corrugation extending transversely to a connecting direction which runs in the coupling region from the electrical system part to the optical system part.

12. The electro-optical system as claimed in claim 1, further comprising:
a second optical system part, wherein a second coupling region of the second optical system part is electromagnetically shielded from the electrical system part by a dedicated shielding element.

13. A laser system, comprising an electro-optical system as claimed in claim 1, the laser system being configured for generating and/or amplifying laser light.
